(19) United States
(12) Patent Application Publication
(10) Pub. No.: US 2023/0220303 A1
(43) Pub. Date: Jul. 13, 2023

(54) WATER-SOLUBLE UNIT DOSE ARTICLE COMPRISING LAUNDRY DETERGENT COMPOSITION CONTAINING DYE FIXATIVE

(71) Applicant: The Procter & Gamble Company, Cincinnati, OH (US)

(72) Inventors: Ming TANG, Beijing (CN); Yanjie WENG, Beijing (CN); Nan ZHANG, Beijing (CN)

(21) Appl. No.: 18/114,472

(22) Filed: Feb. 27, 2023

Related U.S. Application Data
(63) Continuation of application No. PCT/CN2021/112296, filed on Aug. 12, 2021.

(30) Foreign Application Priority Data
Sep. 28, 2020 (WO) PCT/CN2020/118325
Sep. 28, 2020 (WO) PCT/CN2020/118408
Dec. 21, 2020 (WO) PCT/CN2020/138032

(51) Int. Cl. C11D 3/00; C11D 11/00; C11D 17/04; C11D 1/86; C11D 3/37; C11D 3/30; C11D 3/04

(52) U.S. Cl. CPC C11D 3/0021; C11D 11/0017; C11D 17/043; C11D 1/86; C11D 3/3703; C11D 3/30; C11D 3/044; C11D 1/72

(57) ABSTRACT

A water-soluble unit dose article comprising a water-soluble film and a detergent composition encapsulated within the water-soluble film, wherein the water-soluble film is a water-soluble polymer and the detergent composition includes a dye fixative, wherein said detergent composition has a neat pH of from 2.5 to 8.4.

### FIELD OF THE INVENTION

The present invention relates to a water-soluble unit dose article comprising a laundry detergent composition containing a dye fixative.

### BACKGROUND OF THE INVENTION

In recent years, detergent products in the form of unit dose compositions are becoming popular. The unit dose laundry products can provide many benefits compared to conventional detergent powder or liquid detergent products, for example convenience for carrying, no need to measure when used and attractive appearance. Such unit dose products usually comprise a water-soluble film which encapsulates liquid detergent surfactants therein. When added into water, such unit dose compositions would be dissolved to release detergent surfactants. Such water-soluble film comprises a water-soluble polymer preferably selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum.

On the other hand, as detergent products are evolving, consumer needs in the term of cleaning have been well met. However, there are still some other unmet consumer needs in the field of laundry. Particularly, one of the unmet needs is to prevent color fading or color bleeding of colored textiles during the wash cycles.

Colored textiles may fade over several wash cycles due to the release of the dyes from the textiles, especially in the case of dark-colored textiles made of cotton and mixed cotton fabrics. On the other hand, color bleeding might occur, i.e., a differently colored or white textile might be stained with the dye released from dyed textiles as a result relatively high dye concentration in the wash liquor if they were washed at the same time. Color fading or color bleeding would result in a rapid deterioration of the appearance of colored textiles. There is therefore a continuing need for laundry detergent compositions that are capable of preventing color fading and/or color bleeding.

Currently, to solve the problem of color fading or color bleeding, so-called dye fixatives are employed in detergent compositions. Such dye fixatives are usually cationic polymers which could bind negative-charged dyes on the textiles or in the washing liquor so as to prevent the detachment of dyes from colored textiles or redeposition of dyes onto white textiles or textiles with a different dye.

However, these dye fixatives are very sensitive to the formulation of detergent compositions. Many ingredients used in laundry products (e.g. water-soluble polymers used in the unit dose laundry products) might compromise the color protection benefit delivered by the dye fixatives.

Therefore, there are needs for providing a unit dose laundry product containing a dye fixative which is capable of more effectively provide a color protection.

### SUMMARY OF THE INVENTION

It is a surprising and unexpected discovery of the present invention that pH might be very important for a unit dose laundry product containing a dye fixative to deliver the benefit of color protection. Particularly, for a unit dose laundry product comprising a water-soluble film and a detergent composition encapsulated within the water-soluble film in which the water-soluble film comprises a water-soluble polymer and the detergent composition comprises a dye fixative, when the neat pH of the detergent composition is within a certain range (e.g., 2.5 to 8.4), the unit dose laundry product can deliver a significantly improved color protection.

Correspondingly, the present invention in one aspect relates to a water-soluble unit dose article comprising a water-soluble film and a detergent composition encapsulated within the water-soluble film, wherein said water-soluble film comprises a water-soluble polymer and said detergent composition comprises a dye fixative, and wherein said detergent composition has a neat pH of from 2.5 to 8.4.

Preferably, the detergent composition has a neat pH of from 3 to 8.4, preferably 4 to 8.3, more preferably 5 to 8.2, further more preferably from 5 to 8.1, most preferably 5 to 8, for example 4.5, 5, 5.5, 6, 6.5, 7, 7.5, 8, 8.1, 8.2, 8.3 or any ranges therebetween.

In a particularly preferred embodiment of the present disclosure, the detergent composition comprising:
a) from 0.5% to 3%, by weight of the composition, of said dye fixative wherein said dye fixative is selected from the group consisting of reaction products of dimethylamine with epichlorohydrin;
b) from 10% to 35%, by weight of the composition, of said nonionic surfactant comprising C₁₀-C₁₆ ethoxylated alcohol having a weight average degree of ethoxylation ranging from 7 to 9;
c) from 3% to 25%, by weight of the composition, of said anionic surfactant comprising C₁₀-C₁₆ LAS and C₁₀-C₁₆ alkyl ethoxy sulfates; and
d) from 0.1% to 20%, by weight of the composition, of an amine-based surfactant, wherein said amine-based surfactant has the following Formula (I):

R—NHₐ(((CH₂)ₘ—NH)ₓ—(CH₂)ₙ—NH₂)_{b} (I)
wherein R is a linear or branched C₄-C₂₀ alkyl;
wherein a, b, x, m, and n are integers, and a+b=2;
wherein a is 0 or 1; b is 1 or 2; x is an integer from 0 to 10; m is an integer from 1 to 7; and n is an integer from 1 to 7.

In another aspect, the present invention relates to a method of protecting color in a colored fabric comprising contacting the colored fabric with the detergent composition in the water-soluble unit dose article as mentioned hereinabove. Preferably, the protection of the color is achieved by fixing dyes in the colored fabric and/or preventing color fading or color bleeding from the colored fabric.

In another aspect, the present invention relates to a method of preventing color fading or color bleeding of a colored fabric comprising contacting the colored fabric with the laundry detergent composition in the water-soluble unit dose article as mentioned hereinabove.

In another aspect, the present invention relates to a method of fixing dyes in a colored fabric comprising contacting the colored fabric with the laundry detergent composition in the water-soluble unit dose article as mentioned hereinabove.

It is an advantage of the laundry detergent composition to deliver an effective color protection for colored fabrics including e.g. the prevention of color fading and/or color bleeding and dye fixing.

### DETAILED DESCRIPTION OF THE INVENTION

### Definitions

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the term “laundry detergent composition” means a composition for cleaning soiled materials, including fabrics. Such compositions may be used as a pre-laundering treatment, a post-laundering treatment, or may be added during the rinse or wash cycle of the laundering operation. The laundry detergent composition compositions may have a form selected from liquid, powder, unit dose such as single-compartment or multi-compartment unit dose, pouch, tablet, gel, paste, bar, or flake. Preferably, the laundry detergent composition is a liquid or a unit dose composition. The term of “liquid laundry detergent composition” herein refers to compositions that are in a form selected from the group consisting of pourable liquid, gel, cream, and combinations thereof. The liquid laundry detergent composition may be either aqueous or non-aqueous, and may be anisotropic, isotropic, or combinations thereof. The term of “unit dose laundry detergent composition” herein refers to a water-soluble pouch containing a certain volume of liquid wrapped with a water-soluble film.

As used herein, the term “main surfactant” refers to a surfactant that is present in a composition at an amount that is greater than any other surfactant contained by such composition. Similarly, the term “main anionic surfactant” refers to an anionic surfactant that is present in a composition at an amount that is greater than any other anionic surfactant contained by such composition

As used herein, the term “majority surfactant” refers to a surfactant that is present in a composition at an amount that is at least 50% by weight of the total surfactant content in such composition. Similarly, the term “majority anionic surfactant” refers to an anionic surfactant that is present in a composition at an amount that is at least 50% by weight of the total anionic surfactant content in such composition.

As used herein, the term “alkyl” means a hydrocarbyl moiety which is branched or unbranched, substituted or unsubstituted. Included in the term “alkyl” is the alkyl portion of acyl groups.

As used herein, the term “washing solution” refers to the typical amount of aqueous solution used for one cycle of laundry washing, preferably from 1 L to 50 L, alternatively from 1 L to 20 L for hand washing and from 10 L to 50 L for machine washing.

As used herein, the term “soiled fabric” is used non-specifically and may refer to any type of natural or artificial fibers, including natural, artificial, and synthetic fibers, such as, but not limited to, cotton, linen, wool, polyester, nylon, silk, acrylic, and the like, as well as various blends and combinations.

### Water-Soluble Unit Dose Article

The present invention is related to a water-soluble unit dose article comprising a water-soluble film and a liquid laundry detergent composition according to the present invention.

The unit dose article of the present invention comprises a water-soluble film which fully encloses the liquid composition in at least one compartment.

The unit dose article herein is typically a closed structure, made of the water-soluble film enclosing an internal volume which comprises the liquid laundry detergent composition. The unit dose article can be of any form and shape which are suitable to hold and protect the composition, e.g. without allowing the release of the composition from the pouch prior to contact of the pouch to water. The exact execution will depend on factors like the type and amount of the composition in the pouch, the number of compartments in the pouch, the characteristics required for the water-soluble film to hold, protect, and release the composition. The unit dose article may have a substantially, square, rectangular, oval, elliptoid, superelliptical, or circular shape. The shape may or may not include any excess material present as a flange or skirt at the point where two or more films are sealed together. By substantially, we herein mean that the shape has an overall impression of being for example square. It may have rounded corners and/or non-straight sides, but overall it gives the impression of being square for example.

The liquid composition preferably has a density in the range from of 0.9 to 1.3 grams per cubic centimeter, more preferably from 1.0 to 1.1 grams per cubic centimeter, excluding any solid additives, but including any bubbles, if present.

The unit dose pouch comprises a water-soluble film which fully encloses the liquid composition in at least one compartment. The unit dose article may optionally comprise additional compartments; said additional compartments may comprise an additional composition. Said additional composition may be liquid, solid, or mixtures thereof. Alternatively, any additional solid component may be suspended in a liquid-filled compartment. Each compartment may have the same or different compositions. A multi-compartment unit dose form may be desirable for such reasons as: separating chemically incompatible ingredients; or where it is desirable for a portion of the ingredients to be released into the wash earlier or later. The unit dose article may comprise at least one, or even at least two, or even at least three, or even at least four, or even at least five compartments. The unit dose article may comprise two compartments, wherein a first compartment comprises from 5% to 20% by weight of the compartment of a chelant, preferably wherein the chelant is in a solid form.

The multiple compartments may be arranged in any suitable orientation. For example the unit dose article may comprise a bottom compartment, and at least a first top compartment, wherein the top compartment is superposed onto the bottom compartment. The unit dose article may comprise a bottom compartment and at least a first and a second top compartment, wherein the top compartments are arranged side-by-side and are superposed on the bottom compartment; preferably, wherein the article comprises a bottom compartment and at least a first, a second and a third top compartment, wherein the top compartments are arranged side-by-side and are superposed on the bottom compartment.

Alternatively, the compartments may all be positioned in a side-by-side arrangement. In such an arrangement the compartments may be connected to one another and share a dividing wall, or may be substantially separated and simple held together by a connector or bridge. Alternatively, the compartments may be arranged in a ‘tyre and rim’ orientation, i.e. a first compartment is positioned next to a second compartment, but the first compartment at least partially surrounds the second compartment, but does not completely enclose the second compartment.

The film of the unit dose article is soluble or dispersible in water, and preferably has a water-solubility of at least 50%, preferably at least 75% or even at least 95%, as measured by the method set out here after using a glass-filter with a maximum pore size of 20 microns:

50 grams±0.1 gram of film material is added in a pre-weighed 400 ml beaker and 245 ml±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as film material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and polyvinyl alcohols, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films exhibit good dissolution in cold water, meaning unheated water straight from the tap. Preferably such films exhibit good dissolution at temperatures below 25° C., more preferably below 21° C., more preferably below 15° C. By good dissolution it is meant that the film exhibits water-solubility of at least 50%, preferably at least 75% or even at least 95%, as measured by the method set out here after using a glass-filter with a maximum pore size of 20 microns, described above. Preferred films are those supplied by Monosol under the trade references M8630, M8900, M8779, M8310, films described in U.S. Pat. Nos. 6,166,117 and 6,787,512 and PVA films of corresponding solubility and deformability characteristics.

### Dye Fixatives

The dye fixatives of the present invention are cationic polymers. Without being bound by any theory, it is believed that such dye fixatives with positive charges can bind dyes with negative charges through charge interactions and then prevent the dyes out of the textiles or prevent the redeposition of the dyes onto a different colored textiles. Particularly, the dye fixatives may be selected from the group consisting of reaction products of: i) polyamines with cyanamides and organic and/or inorganic acids, ii) cyanamides with aldehydes and ammonium salts, iii) cyanamides with aldehydes and amines, or iv) amines with epichlorohydrin. Preferably, the dye fixative may be selected from the group consisting of reaction products of amines with epichlorohydrin in which the amines are primary, secondary or tertiary amines. More preferably, the dye fixative may be selected from the group consisting of reaction products of dimethylamine with epichlorohydrin. Most preferably, the dye fixative may be poly(2-hydroxypropyldimethylammonium chloride), also called poly(dimethylamine-co-epichlorohydrin), for example the polymer commercially available under the trade name of TEXCARE DFC 6 from Clariant (CAS #: 25988-97-0).

The term of “amines” comprises monoamines and polyamines. The monoamines used herein may be primary, secondary and tertiary amines. They may be aliphatic amines, for example dialkylamines, especially dimethylamine, alicyclic amines, for example cyclohexylamine, and aromatic amines, for example aniline. However, the amines used herein may also simultaneously have aliphatic, alicyclic and aromatic substituents. In addition, it is also possible to use heterocyclic compounds, for example pyridine. The term “polyamines” herein includes, for example diamines, triamines, tetraamines, etc, and also the analogous N-alkylpolyamines and N,N-dialkylpolyamines. Examples thereof are ethylenediamine, propylenediamine, butylenediamine, pentylenediamine, hexylenediamine, diethylenetriamine, triethylenetetraamine and higher polyamines. Particularly preferred polyamines may be ethylenediamine, diethylenetriamine and dimethylaminopropylamine. The ammonium salts are salts of ammonia, especially ammonium chloride or the abovementioned amines or polyamines with different inorganic or organic acids, or else quaternary ammonium salts.

The cyanamides may be cyanamide or dicyandiamide. Aldehydes used herein may include, for example, aliphatic aldehydes such as formaldehyde, acetaldehyde, propionaldehyde, butyraldehyde; dialdehydes, for example glyoxal; unsaturated aldehydes, for example acrolein, crotonaldehyde and aromatic aldehydes, for example benzaldehyde. Particularly preferred aldehydes may be aliphatic aldehydes such as formaldehyde.

The dye fixatives used herein may also be homo- and copolymers based on diallyldimethylammonium chloride (DADMAC). Copolymers based on DADMAC contain, as further components, other vinylic monomers, for example vinylimidazole, vinylpyrrolidone, vinyl alcohol, vinyl acetate, (meth) acrylic acid/ester, acrylamide, styrene, styrenesulfonic acid, acrylamidomethylpropanesulfonic acid (AMPS), etc. Homopolymers based on DADMAC are obtainable under the trade names Dodigen® 3954, Dodigen 4033 and Genamin PDAC (from Clariant).

Preferably, the dye fixative suitable for use in the present disclosure can be selected from the group consisting of reaction products of amines with epichlorohydrin in which the amines are primary, secondary or tertiary amines. More preferably, the dye fixative suitable for use in the present invention can be selected from the group consisting of reaction products of dimethylamine with epichlorohydrin. Most preferably, the dye fixative may be poly(2-hydroxypropyldimethylammonium chloride).

In one embodiment, the dye fixative is poly(2-hydroxypropyldimethylammonium chloride) of formula (I):

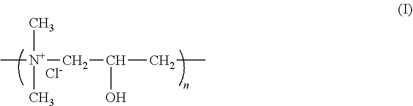

wherein n is an integer from 5 to 1000.

The dye fixative in the composition according to the present disclosure may be present in an amount ranging from 0.02% to 5%, preferably from 0.05% to 2%, more preferably from 0.1% to 1.5%, most preferably from 0.15% to 0.9%, for example 0.2%, 0.3%, 0.4%, 0.5%, 0.6%, 0.7%, 0.8%, 0.9%, 1.0% or any ranges therebetween, by weight of the composition.

### Amine-Based Surfactant:

The laundry detergent composition of the present invention may comprise an amine-based surfactant. Particularly, the amine-based surfactant may have the following Formula (I)

R—NHₐ(((CH₂)ₘ—NH)ₓ—(CH₂)ₙ—NH₂)_{b} (I)

wherein R is a linear or branched C₄-C₂₀ alkyl, preferably C₈-C₁₈ alkyl, more preferably C₁₀-C₁₆ alkyl;

wherein a, b, x, m, and n are integers, and a+b=2;

wherein a is 0 or 1, preferably 0; b is 1 or 2, preferably 2; x is an integer from 0 to 10, preferably from 0 to 8, more preferably from 0 to 5, most preferably from 0 to 3, for example 0, 1, or 2; m is an integer from 1 to 7, preferably from 1 to 4, more preferably from 2 to 4, most preferably 3; and n is an integer from 1 to 7, preferably from 1 to 4, more preferably from 2 to 4, most preferably 3.

Particularly, the amine-based surfactant suitable for the present invention may be C₁₂-C₁₆ alkyl dipropylene triamine, preferably dodecyldipropylene triamine, more preferably a triamine compound having the following formula:

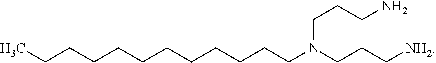 [SMILES: CCCCCCCCCCCCN(CCCN)CCCN]

In some embodiments, the amine-based surfactant in the detergent composition according to the present disclosure may be present in an amount ranging from 0.4% to 12%, preferably from 0.7% to 10%, more preferably from 1% to 8%, by weight of the detergent composition.

### Anionic Surfactant

The laundry detergent composition of the present invention may comprise an anionic surfactant. Particularly, the laundry detergent composition of the present invention may comprise from 0.1% to 50% by weight of the composition, of an anionic surfactant.

Preferably, the anionic surfactant may comprise an anionic surfactant selected from the group consisting of C₆-C₂₀ linear alkylbenzene sulfonates (LAS), C₆-C₂₀ alkyl sulfates (AS), C₆-C₂₀ alkyl alkoxy sulfates (AAS), C₆-C₂₀ methyl ester sulfonates (IVIES), C₆-C₂₀ alkyl ether carboxylates (AEC), and any combinations thereof. More preferably, the anionic surfactant may comprise a C₆-C₂₀ LAS and optionally an additional anionic surfactant such as a C₆-C₂₀ AS and/or a C₆-C₂₀ AAS. In one embodiment, LAS is C₁₀-C₁₆ LAS, preferably C₁₂-C₁₄ LAS.

The LAS is normally prepared by sulfonation (using SO₂ or SO₃) of alkylbenzenes followed by neutralization. Suitable alkylbenzene feedstocks can be made from olefins, paraffins or mixtures thereof using any suitable alkylation scheme, including sulfuric and HF-based processes. By varying the precise alkylation catalyst, it is possible to widely vary the position of covalent attachment of benzene to an aliphatic hydrocarbon chain. Accordingly, the LAS herein can vary widely in 2-phenyl isomer and/or internal isomer content.

In some embodiments of the laundry detergent composition, C₆-C₂₀ LAS may be present in an amount ranging from 1% to 100%, preferably from 10% to 99%, more preferably from 20% to 95%, most preferably from 30% to 90%, for example 40%, 50%, 60%, 70%, 80%, 90% or any ranges therebetween, by weight of the anionic surfactant.

In some embodiments of the laundry detergent composition, the level of LAS is preferably higher than that of any other anionic surfactant contained by such composition, i.e., the LAS is the main anionic surfactant in such composition.

The anionic surfactant suitable for use in the present disclosure may further comprise C₆-C₂₀ alkyl sulfates (AS), C₆-C₂₀ alkyl alkoxy sulfates (AAS), C₆-C₂₀ methyl ester sulfonates (IVIES), C₆-C₂₀ alkyl ether carboxylates (AEC), or any combinations thereof. For example, the laundry detergent composition may contain a C₆-C₂₀ alkyl alkoxy sulfates (AAₓS), wherein x is about 1-30, preferably about 1-15, more preferably about 1-10, most preferably x is about 1-3. The alkyl chain in such AAₓS can be either linear or branched, with mid-chain branched AAₓS surfactants being particularly preferred. A preferred group of AAₓS include C₁₂-C₁₄ alkyl alkoxy sulfates with x of about 1-3. The amount of AAₓS surfactant(s) in the laundry detergent composition of the present invention may range from about 0.05% to about 100%, preferably from about 0.1% to about 80%, more preferably from about 0.5% to about 50%, most preferably from about 1% to about 30%, for example 5%, 10%, 20%, 30%, 40%, 50%, 60%, 70%, 80%, 90% or any ranges therebetween, by weight of the composition.

In some embodiments, the weight ratio of LAS to AAₓS is at least 0.6, preferably at least 0.8, more preferably at least 0.9, most preferably at least 1, for example 0.6, 0.7, 0.8, 0.9, 1, 1.2, 1.5, 2, 2.5, 3, 4, 5, 8, 10 or any ranges therebetween.

The anionic surfactant in the composition according to the present disclosure may be present in an amount ranging from 0.1% to 45%, preferably from 0.5% to 40%, more preferably from 1% to 35%, most preferably from 2% to 30%, for example 2%, 3%, 4%, 5%, 6%, 7%, 8%, 9%, 10%, 15%, 20%, 25%, 30%, 35%, 40%, 45%, 50% or any ranges therebetween, by weight of the composition.

In some embodiments of the present disclosure, the anionic surfactant in the composition according to the present disclosure may comprise less than 30%, preferably less than 20%, more preferably less than 10%, most preferably less than 5%, of soap by weight of the anionic surfactant.

### Nonionic Surfactants (NI)

The laundry detergent composition of the present invention may comprise a nonionic surfactant. Particularly, the laundry detergent composition of the present invention may comprise from 0.1% to 50% by weight of the composition, of a nonionic surfactant.

The nonionic surfactant may comprise a nonionic surfactant selected from the group consisting of alkyl alkoxylated alcohols, alkyl alkoxylated phenols, alkyl polysaccharides, polyhydroxy fatty acid amides, alkoxylated fatty acid esters, alkyl polyglycosides (APG), methyl ester ethoxylates (MEE), sucrose esters, sorbitan esters and alkoxylated derivatives of sorbitan esters, and any combinations thereof. Preferably, the nonionic surfactant may comprise a C₆-C₂₀ alkoxylated alcohol having a weight average degree of alkoxylation ranging from 1 to 20, preferably from 5 to 15, more preferably from 7 to 10. More preferably, the nonionic surfactant may comprise a C₈-C₁₈ ethoxylated alcohol having a weight average degree of ethoxylation ranging from 1 to 20, preferably from 5 to 15, more preferably from 7 to 10.

Non-limiting examples of nonionic surfactants suitable for use herein include: C₁₂-C₁₈ alkyl ethoxylates, such as C₁₂-C₁₄ alkyl ethoxylates with EO 7-9; Neodol® nonionic surfactants available from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block alkyl polyamine ethoxylates such as Pluronic® available from BASF; C₁₄-C₂₂ mid-chain branched alkyl alkoxylates, BAEx, wherein x is from about 1 to about 30; alkylpolysaccharides, specifically alkylpolyglycosides; polyhydroxy fatty acid amides; and ether capped poly(oxyalkylated) alcohol surfactants. Also useful herein as nonionic surfactants are alkoxylated ester surfactants such as those having the formula R¹C(O)O(R₂O)nR³ wherein R¹ is selected from linear and branched C₆-C₂₂ alkyl or alkylene moieties; R² is selected from C₂H₄ and C₃H₆ moieties and R³ is selected from H, CH₃, C₂H₅ and C₃H₇ moieties; and n has a value between about 1 and about 20. Such alkoxylated ester surfactants include the fatty methyl ester ethoxylates (MEE) and are well-known in the art.

In a particular embodiment, the alkoxylated nonionic surfactant contained by the laundry detergent composition of the present invention is a C₆-C₂₀ alkoxylated alcohol, preferably C₈-C₁₈ alkoxylated alcohol, more preferably C₁₀-C₁₆ alkoxylated alcohol. The C₆-C₂₀ alkoxylated alcohol is preferably an alkyl alkoxylated alcohol with an average degree of alkoxylation of from about 1 to about 50, preferably from about 3 to about 30, more preferably from about 5 to about 20, even more preferably from about 5 to about 9. The alkoxylation herein may be ethoxylation, propoxylation, or a mixture thereof, but preferably is ethoxylation. In one embodiment, the alkoxylated nonionic surfactant is C₆-C₂₀ ethoxylated alcohol, preferably C₈-C₁₈ alcohol ethoxylated with an average of about 5 to about 20 moles of ethylene oxides, more preferably C₁₀-C₁₆ alcohol ethoxylated with an average of about 5 to about 9 moles of ethylene oxides. The most preferred alkoxylated nonionic surfactant is C₁₂-C₁₅ alcohol ethoxylated with an average of about 7 moles of ethylene oxide, e.g., Neodol® 25-7 commercially available from Shell.

The nonionic surfactant in the composition according to the present disclosure may be present in an amount ranging from 1% to 45%, preferably from 2% to 40%, more preferably from 3% to 35%, most preferably from 4% to 30%, for example 4%, 5%, 6%, 7%, 8%, 9%, 10%, 11%, 12%, 13%, 14%, 15%, 20%, 25%, 30% or any ranges therebetween, by weight of the composition.

In some embodiments, the weight ratio of the nonionic surfactant to the anionic surfactant is between 1.5 and 20, preferably between 1.7 and 15, more preferably between 1.9 and 10, and most preferably between 2 and 8, for example 1.5, 1.6, 1.7, 1.8, 1.9, 2, 2.1, 2.2, 2.3, 2.5, 3, 4, 5, 6, 7, 8, 9, 10 and any ranges therebetween.

### Other Ingredients

The laundry detergent composition according to the present disclosure may further comprise from 0.01% to 10%, preferably from 0.1% to 5%, more preferably from 0.2% to 3%, most preferably from 0.3% to 2%, by weight of the composition, of a surfactant boosting polymer, preferably polyvinyl acetate grafted polyethylene oxide copolymer.

The laundry detergent composition of the present invention may further comprise a cationic surfactant. Non-limiting examples of cationic surfactants include: quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; and amino surfactants, specifically amido propyldimethyl amine (APA).

The laundry detergent composition according to the present disclosure may further comprise from 0.01% to 10%, preferably from 0.1% to 5%, more preferably from 0.2% to 3%, most preferably from 0.3% to 2%, by weight of the composition, of an amphoteric surfactant, preferably an amine oxide, more preferably C₆-C₂₀ alkyldimethyl amine oxide, most preferably C₁₀-C₂₀ alkyldimethyl amine oxide.

The laundry detergent composition herein may comprise adjunct ingredients. Suitable adjunct materials include but are not limited to: builders, chelating agents, rheology modifiers, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, perfumes, perfume microcapsules, structure elasticizing agents, fabric softeners, carriers, hydrotropes, processing aids, solvents, hueing agents, structurants and/or pigments. The precise nature of these adjunct ingredients and the levels thereof in the laundry detergent composition will depend on the physical form of the composition and the nature of the cleaning operation for which it is to be used.

In some embodiments, the laundry detergent composition according to the present disclosure may further comprise from 0.01% to 10%, preferably from 0.1% to 5%, more preferably from 0.2% to 3%, most preferably from 0.3% to 2%, by weight of the composition, of a fatty acid.

The laundry detergent composition according to the present disclosure may further comprise a pH adjuster which is preferably selected from sodium hydroxide, potassium hydroxide, monoethanolamine (MEA), triethanolamine (TEA) and any combinations. Preferably, the pH adjuster may comprise MEA. The pH adjuster may be present in an amount which is sufficient to provide a target neat pH. In some embodiments, the pH adjuster may be present in an amount ranging of from 0.1% to 3%, e.g. 0.2%, 0.3%, 0.5%, 0.7%, 1%, 1.5%, 2%, 2.5% or any ranges therebetween, by weight of the composition.

### Process for Making the Water-Soluble Unit Dose Article

The water-soluble unit dose article of the invention (e.g. water-soluble pouch) may be made using any suitable equipment and method. The film is preferably wetting, more preferably heated to increase the malleability thereof. Even more preferably, the method also involves the use of a vacuum to draw the film into a suitable mould. The vacuum drawing the film into the mould can be applied for 0.2 to 5 seconds, preferably 0.3 to 3 or even more preferably 0.5 to 1.5 seconds, once the film is on the horizontal portion of the surface. This vacuum may preferably be such that it provides an under-pressure of between −100 mbar to −1000 mbar, or even from −200 mbar to −600 mbar.

The moulds, in which the pouches are made, can have any shape, length, width and depth, depending on the required dimensions of the pouches. The moulds can also vary in size and shape from one to another, if desirable. For example, it may be preferred that the volume of the final pouches is between 5 and 300 ml, or even 10 and 150 ml or even 20 and 100 ml and that the mould sizes are adjusted accordingly.

Heat can be applied to the film, in the process commonly known as thermoforming, by any means. For example, the film may be heated directly by passing it under a heating element or through hot air, prior to feeding it onto the surface or once on the surface. Alternatively, it may be heated indirectly, for example by heating the surface or applying a hot item onto the film. Most preferably, the film is heated using an infra red light. The film is preferably heated to a temperature of 50 to 120° C., or even 60 to 90° C. Alternatively, the film can be wetted by any mean, for example directly by spraying a wetting agent (including water, solutions of the film material or plasticizers for the film material) onto the film, prior to feeding it onto the surface or once on the surface, or indirectly by wetting the surface or by applying a wet item onto the film.

Once a film has been heated/wetted, it is drawn into an appropriate mould, preferably using a vacuum. The filling of the moulded film can be done by any known method for filling (moving) items. The most preferred method will depend on the product form and speed of filling required. Preferably the moulded film is filled by in-line filling techniques. The filled, open pouches are then closed, using a second film, by any suitable method. Preferably, this is also done while in horizontal position and in continuous, constant motion. Preferably the closing is done by continuously feeding a second material or film, preferably water-soluble film, over and onto the web of open pouches and then preferably sealing the first film and second film together, typically in the area between the moulds and thus between the pouches.

Preferred methods of sealing include heat sealing, solvent welding, and solvent or wet sealing. It is preferred that only the area which is to form the seal, is treated with heat or solvent. The heat or solvent can be applied by any method, preferably on the closing material, preferably only on the areas which are to form the seal. If solvent or wet sealing or welding is used, it may be preferred that heat is also applied. Preferred wet or solvent sealing/welding methods include applying selectively solvent onto the area between the moulds, or on the closing material, by for example, spraying or printing this onto these areas, and then applying pressure onto these areas, to form the seal. Sealing rolls and belts as described above (optionally also providing heat) can be used, for example.

The formed pouches can then be cut by a cutting device. Cutting can be done using any known method. It may be preferred that the cutting is also done in continuous manner, and preferably with constant speed and preferably while in horizontal position. The cutting device can, for example, be a sharp item or a hot item, whereby in the latter case, the hot item ‘burns’ through the film/sealing area.

### Method of Use

Another aspect of the present invention is directed to a method of using the water-soluble unit dose article to treat a fabric. Such method can deliver a color protection benefit. The method comprises the step of administering one or more water-soluble unit dose article into a laundry washing basin comprising water to form a washing solution. The washing solution in a laundry washing basin herein preferably has a volume from 1 L to 50 L, alternatively from 1 L to 20 L for hand washing and from 10 L to 50 L for machine washing. The temperatures of the laundry washing solution preferably range from 5° C. to 60° C.

### Test Method

### Test 1: Dye Bleeding Test

Dye bleeding test is conducted by using Tergotometer (Model: RHLQ1V, from Research Institute of Daily Chemical Industry (RIDCI)) as below:
1) Cut ˜1.0 g of test fabric (ASIE-130 or ASIE-133) in each piece for each tube of tergotometer;
2) Add 1 L reverse osmosis (RO) water that has water hardness level of about 9 gpg (with a Ca²⁺-to-Mg²⁺ weight ratio of about 4:1) heated to 40° C. with a water bath;
3) Dissolve one unit dose article to form a wash liquor with a detergent dosage of about 2000 ppm;
4) Take out ˜30 ml solution to measure L*/a*/b* before wash, (measured with UltraScan VIS (from HunterLab, Virginia, USA) by using 5 cm×1 cm sample cell);
5) Add one piece of 1.0 g test fabric into each tube and wash for about 20 minutes;
6) Take out ˜30 ml solution to measure L*/a*/b under same condition as Step 5); and
7) Calculate ΔE based on before and after wash measurement, the higher ΔE indicates the worse dye bleeding.

### EXAMPLES

### Example 1: Improved Color Protection when Detergent Composition has a pH within a Certain Range

Five (5) sample unit dose article comprising liquid detergent compositions were prepared containing the following ingredients, in which all samples contain a dye fixative, an anionic surfactant, non-ionic surfactant and an amine-based surfactant except that the liquid detergent compositions have different neat pH which was adjusted by adding citric acid and/or sodium hydroxide. The liquid detergent compositions (˜10 ml) were encapsulated into compartment(s) of the unit dose by using a polyvinyl-alcohol-based film in which the PVA film and the shape of the unit dose were the same with CN Ariel Laundry two chamber side-by-side pouches.

TABLE 1

| Ingredients | | | | | |
|---|---|---|---|---|---|
| (weight %) | Sample 1 | Sample 2 | Sample 3 | Sample 4 | Sample 5 |
| Dye fixative¹ | 0.6% | 0.6% | 0.6% | 0.6% | 0.6% |
| C₁₂₋₁₄EO₇ | 18.3% | 18.3% | 18.3% | 18.3% | 18.3% |
| C₁₂₋₁₄AE₁₋₃S | 5.7% | 5.7% | 5.7% | 5.7% | 5.7% |
| C₁₁₋₁₃LAS | 7.5% | 7.5% | 7.5% | 7.5% | 7.5% |
| Amine-based | 7.1% | 7.1% | 7.1% | 7.1% | 7.1% |
| surfactant² | | | | | |
| pH adjuster³ | To target | To target | To target | To target | To target |
| | pH | pH | pH | pH | pH |
| Solvent | Balance | Balance | Balance | Balance | Balance |
| Neat pH | 5 | 6.5 | 7.5 | 8.5 | 9.5 |

¹Dye fixative poly(2-hydroxypropyldimethylammonium chloride) commercially available under the trade name of TEXCARE DFC 6 from Clariant.
²Triameen Y12D commercially available from AkzoNobel
³Citric acid and/or sodium hydroxide

In accordance with Test 1: Dye bleeding test as described hereinabove in which fabrics colored by Blue dye (ASIE-133) or Direct Red dye (ASIE-130) is respectively used, the ΔE for these samples was measured as a measurement of dye bleeding. The higher ΔE indicates the worse dye bleeding, while the lower ΔE indicates the more effective color protection.

Red Fabrics

The results for red colored fabrics are shown in the table below. Surprisingly, the inventors discovered that, when the detergent composition contained in the unit dose article has a neat pH within a certain range, the unit dose article can deliver an improved color protection, i.e. a significantly reduced color bleeding (1.55 to 1.82 of ΔE) in Samples 1 to 3 with a neat pH of 5 to 7.5 compared to Samples 4 and 5 with a neat pH of 8.5 and 9.5 (2.20 to 2.75 of ΔE).

TABLE 2

| | Sample 1 | Sample 2 | Sample 3 | Sample 4 | Sample 5 |
|---|---|---|---|---|---|
| ΔE | 1.59 | 1.82 | 1.55 | 2.20 | 2.75 |
| Neat pH | 5 | 6.5 | 7.5 | 8.5 | 9.5 |
| Notes | Inventive | Inventive | Inventive | Comparative | Comparative |
| | Sample | Sample | Sample | Sample | Sample |

Blue Fabrics

Another test by using fabrics colored by Blue dye (ASIE-133) was conducted to show the color protection for a different color (i.e., blue) by using Test 1: Dye bleeding Test described hereinabove. As shown in the table below, the results also indicate an improved color protection can be delivered when the neat pH of the detergent composition is within a certain range. Particularly, Samples 2 and 3 with a neat pH of 6.5 to 7.5 shows a significantly reduced color bleeding (3.30 and 2.80 of ΔE) compared to Sample 4 with a neat pH of 8.5 (5.72 of ΔE).

TABLE 3

| | Sample 2 | Sample 3 | Sample 4 |
|---|---|---|---|
| ΔE | 3.30 | 2.80 | 5.72 |
| Neat pH | 6.5 | 7.5 | 8.5 |
| Notes | Inventive | Inventive | Comparative |
| | Sample | Sample | Sample |

### Example 2: Further Improved Color Protection when MEA is Used as pH Adjuster Compared to Sodium Hydroxide

In order to explore if pH adjuster has an impact on color protection performance, two (2) sample unit dose article comprising liquid detergent compositions were prepared containing the following ingredients, in which all samples contain a dye fixative, an anionic surfactant, non-ionic surfactant and an amine oxide except that the liquid detergent compositions have different pH adjusters (sodium hydroxide and citric acid for Sample 6 and monoethanolamine, i.e. MEA, for Sample 7). The liquid detergent compositions (˜10 ml) were encapsulated into compartment(s) of the unit dose by using a polyvinyl-alcohol-based film in which the PVA film and the shape of the unit dose were the same with CN Ariel Laundry two chamber side-by-side pouches.

In accordance with Test 1: Dye bleeding test as described hereinabove in which fabrics colored by Blue dye (ASIE-133) is used, the ΔE for these samples was measured as a measurement of dye bleeding. As shown in the table below, it is surprising that using MEA as pH adjuster in the formula can deliver a further improved color protection. i.e. a significant reduction of ΔE.

TABLE 4

| Ingredients | | |
|---|---|---|
| (weight %) | Sample 6 | Sample 7 |
| Dye fixative¹ | 0.7% | 0.7% |
| C₁₂₋₁₄EO₇ | 9.1% | 9.1% |
| C₁₄₋₁₅EO₇ | 9.1% | 9.1% |
| C₁₂₋₁₄AE₁₋₃S | 5.6% | 5.6% |
| C₁₁₋₁₃LAS | 7.5% | 7.5% |
| Fatty Acid | 1.1% | 1.1% |
| Dodecyldimethyl Amine Oxide | 4% | 4% |
| NaOH | 0.8% | — |
| MEA | — | 1.8% |
| Citric Acid | 0.45% | — |
| Solvent | Balance | Balance |
| Neat pH | 7.5 | 7.5 |
| ΔE | 2.6 | 2.0 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble unit dose article comprising a water-soluble film and a detergent composition encapsulated within the water-soluble film,
wherein said water-soluble film comprises a water-soluble polymer and said detergent composition comprises a dye fixative, and
wherein said detergent composition has a neat pH of from about 2.5 to about 8.4.

2. The water-soluble unit dose article according to claim 1, wherein said water-soluble polymer is selected from the group consisting of: polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyamides, polyacrylamide, copolymers of maleic/acrylic acids, polysaccharides, natural gums and any combinations thereof.

3. The water-soluble unit dose article according to claim 1, wherein said water-soluble polymer is polyvinyl alcohol.

4. The water-soluble unit dose article according to claim 1, wherein said dye fixative is selected from the group consisting of:
i) reaction products of polyamines with cyanamides and acids,
ii) reaction products of cyanvamides with aldehydes and ammonium salts,
iii) reaction products of cyanamides with aldehydes and amines, or
iv) reaction products of amines with epichlorohydrin; and
v) any combinations thereof.

5. The water-soluble unit dose article according to claim 1, wherein said dye fixative is present in an amount ranging from about 0.02% to about 5%, by weight of the detergent composition.

6. The water-soluble unit dose article according to claim 1, wherein said detergent composition has a neat pH of from about 3 to about 8.4.

7. The water-soluble unit dose article according to claim 1, wherein said detergent composition further comprises:
from about 0.1% to about 50%, by weight of the composition, of a nonionic surfactant; or
from about 0.1% to about 50%, by weight of the composition, of an anionic surfactant; or
from about 0.01% to about 25%, by weight of the composition, of an amine-based surfactant; or
mixtures thereof.

8. The water-soluble unit dose article according to claim 1, wherein said nonionic surfactant is present in an amount ranging from about 1% to about 45%.

9. The water-soluble unit dose article according to claim 1, wherein said anionic surfactant is present in an amount ranging from about 0.1% to about 45%.

10. The water-soluble unit dose article according to claim 1, wherein said detergent composition further comprises an amine-based surfactant which is present in an amount ranging from about 0.4% to about 12%.

11. The water-soluble unit dose article according to claim 1, wherein said detergent composition further comprises a pH adjuster selected from sodium hydroxide, potassium hydroxide, monoethanolamine (MEA), triethanolamine (TEA) and any combinations thereof.

12. The water-soluble unit dose article according to claim 11, wherein said pH adjuster comprises MEA.

13. The water-soluble unit dose article according to claim 1, wherein said detergent composition comprises:
a) from about 0.5% to about 3%, by weight of the composition, of said dye fixative wherein said dye fixative is selected from the group consisting of reaction products of dimethylamine with epichlorohydrin;
b) from about 10% to about 35%, by weight of the composition, of said nonionic surfactant comprising C₁₀-C₁₆ ethoxylated alcohol having a weight average degree of ethoxylation ranging from 7 to 9; and
c) from about 3% to about 25%, by weight of the composition, of said anionic surfactant comprising C₁₀-C₁₆ LAS and C₁₀-C₁₆ alkyl ethoxy sulfates;
wherein said detergent composition has a neat pH of from 6 to 8.

14. A method of protecting color in a colored fabric comprising contacting the colored fabric with the detergent composition in the water-soluble unit dose article according to claim 1.

15. The method according to claim 14, wherein the protection of the color is achieved by fixing dyes in the colored fabric and/or preventing color fading or color bleeding from the colored fabric.

16. A water-soluble unit dose article comprising a water-soluble film and a detergent composition encapsulated within the water-soluble film,
wherein said water-soluble film comprises a water-soluble polymer and said detergent composition comprises:
a) from about 0.01% to about 10%, by weight of the composition, of a dye fixative; and
b) from about 0.1% to about 20%, by weight of the composition, of an amine-based surfactant,
wherein said amine-based surfactant has the following Formula (I):
R—NHₐ(((CH₂)ₘ—NH)ₓ—(CH₂)ₙ—NH₂)_{b} (I)
wherein R is a linear or branched C₄-C₂₀ alkyl;
wherein a, b, x, m, and n are integers, and a+b=2;
wherein a is 0 or 1; b is 1 or 2; x is an integer from 0 to 10; m is an integer from 1 to 7; and n is an integer from 1 to 7.
wherein said detergent composition has a neat pH of from about 2.5 to about 8.4.

17. The water-soluble unit dose article according to claim 16, wherein R is a linear or branched C₈-C₁₈ alkyl, a is 0; b is 2; x is an integer from 0 to 5; m from 2 to 4; and n is an integer from 2 to 4.

18. The water-soluble unit dose article according to claim 16, wherein said amine-based surfactant is C₁₂-C₁₆ alkyl dipropylene triamine.

19. The water-soluble unit dose article according to claim 16, wherein said amine-based surfactant is dodecyldipropylene triamine.

20. The water-soluble unit dose article according to claim 16, wherein said amine-based surfactant is a triamine compound having the following formula: 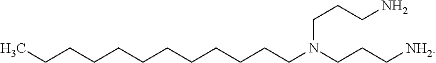 [SMILES: CCCCCCCCCCCCN(CCCN)CCCN]
